(19) United States
(12) Patent Application Publication
(10) Pub. No.: US 2015/0260750 A1
(43) Pub. Date: Sep. 17, 2015

(54) ELECTRONIC APPARATUS AND PROGRAM

(71) Applicant: NIKON CORPORATION, Tokyo (JP)

(72) Inventors: Takayuki Sawajiri, Yokohama (JP); Akira Yamaguchi, Kawaguchi (JP); Syugen Kin, Tokyo (JP)

(73) Assignee: NIKON CORPORATION, Tokyo (JP)

(21) Appl. No.: 14/661,409

(22) Filed: Mar. 18, 2015

Related U.S. Application Data
(63) Continuation of application No. PCT/JP2013/075349, filed on Sep. 19, 2013.

(30) Foreign Application Priority Data
Sep. 19, 2012 (JP) 2012-206310

(51) Int. Cl. G01P 13/00; G01P 15/00

(52) U.S. Cl. CPC G01P 13/00; G01P 15/00

(57) ABSTRACT

An electronic apparatus includes: a sensor unit configured to detect displacement information of a body including at least acceleration data; a still determination unit configured to determine whether or not the body is in a still state based on a change in a standard deviation with respect to the displacement information for a predetermined number of detections detected by the sensor unit; a gravity calculation unit configured to determine a start of a motion of the body based on a determination result determined by the still determination unit and calculate a gravity component based on first acceleration data that is acceleration data in the start of the motion of acceleration data detected by the sensor unit; a correction unit configured to correct second acceleration data that is acceleration data detected by the sensor unit while the body is moving, based on the gravity component calculated by the gravity calculation unit; and a motion determination unit configured to determine the motion based on the second acceleration data corrected by the correction unit.

### CROSS-REFERENCE TO RELATED APPLICATION

This is a Continuation Application of International Application No. PCT/JP2013/75349 filed on Sep. 19, 2013, which claims priority on Japanese Patent Application No. 2012-206310 filed on Sep. 19, 2012. The contents of the aforementioned applications are incorporated herein by reference.

### BACKGROUND

1. Field of the Invention

The present invention relates to an electronic apparatus and a program.

2. Background

Recently, in electronic apparatuses, a technology is known in which a movement determination such as a motion determination is performed (for example, refer to Japanese Patent Application, Publication No. 2011-47879A). For example, in the technology of Japanese Patent Application, Publication No. 2011-47879A, an electronic apparatus separates acceleration data detected by an acceleration detection means into a still component (gravity component) obtained through a low-pass filter process and a motion component. The motion component is generated by excluding the above-described still component (gravity component) from the acceleration component data detected by the acceleration detection means. The electronic apparatus disclosed in Japanese Patent Application, Publication No. 2011-47879A determines the motion of the apparatus (the electronic apparatus, a body) based on the motion component excluding the still component (gravity component).

### SUMMARY

However, the electronic apparatus as described above bases on the still component (gravity component) obtained through a low-pass filter process, and therefore there is a case in which the still component (gravity component) cannot be accurately obtained and the motion component cannot be correctly separated. Thus, for example, there is a case in which motions such as a linear movement and a circular movement cannot be correctly determined.

An object of an aspect of the present invention is to provide an electronic apparatus and a program capable of improving a determination rate of the motion of the apparatus (body).

An electronic apparatus according to an aspect of the present invention includes: a sensor unit configured to detect displacement information of a body including at least acceleration data; a still determination unit configured to determine whether or not the body is in a still state based on a change in a standard deviation with respect to the displacement information for a predetermined number of detections detected by the sensor unit; a gravity calculation unit configured to determine a start of a motion of the body based on a determination result determined by the still determination unit and calculate a gravity component based on first acceleration data that is acceleration data in the start of the motion of acceleration data detected by the sensor unit; a correction unit configured to correct second acceleration data that is acceleration data detected by the sensor unit while the body is moving, based on the gravity component calculated by the gravity calculation unit; and a motion determination unit configured to determine the motion based on the second acceleration data corrected by the correction unit.

Further, a program according to another aspect of the present invention causes a computer to execute: a still determination step of, by way of a still determination unit, determining whether or not a body is in a still state based on a change in a standard deviation with respect to displacement information for a predetermined number of detections detected by a sensor unit, the sensor unit being configured to detect the displacement information of the body including at least acceleration data; a gravity component calculation step of, by way of a gravity calculation unit, determining a start of a motion of the body based on a determination result determined in the still determination step and calculating a gravity component based on first acceleration data that is acceleration data in the start of the motion of acceleration data detected by the sensor unit; a correction step of, by way of a correction unit, correcting second acceleration data that is acceleration data detected by the sensor unit while the body is moving, based on the gravity component calculated by the gravity calculation unit; and a motion determination step of, by way of a motion determination unit, determining the motion based on the second acceleration data corrected in the correction step.

According to an aspect of the present invention, it is possible to improve a determination rate of the motion of the apparatus (body).

### BRIEF DESCRIPTION OF THE DRAWINGS

FIG. 1 is a schematic view showing an example of an external appearance of an electronic apparatus according to a first embodiment.

FIG. 2A is a view showing an example of a motion determined by the electronic apparatus in the present embodiment.

FIG. 2B is a view showing an example of a motion determined by the electronic apparatus in the present embodiment.

FIG. 2C is a view showing an example of a motion determined by the electronic apparatus in the present embodiment.

FIG. 3 is a block diagram showing the electronic apparatus in the first embodiment.

FIG. 4 is a diagram showing a change in a standard deviation of angular velocity data in the first embodiment.

FIG. 5A is a diagram showing an example of a change in a gravity component in the first embodiment.

FIG. 5B is a diagram showing an example of a change in a gravity component when a low-pass filter of the related art is used.

FIG. 6A is a diagram showing an example of a simplification process of a path in the first embodiment.

FIG. 6B is a diagram showing an example of a simplification process of a path in the first embodiment.

FIG. 6C is a diagram showing an example of a simplification process of a path in the first embodiment.

FIG. 7 is a diagram used to describe a first simplification process of a path in the first embodiment.

FIG. 8A is a diagram showing an example of a motion determination using a path in the first embodiment.

FIG. 8B is a diagram showing an example of a motion determination using a path in the first embodiment.

FIG. 9 is a flowchart showing a process of a motion determination of the electronic apparatus in the first embodiment.

FIG. 10 is a block diagram showing an electronic apparatus in a second embodiment.

FIG. 11 is a diagram showing an example of angular velocity data in an arc movement.

FIG. 12 is a flowchart showing a process of a motion determination of the electronic apparatus in the second embodiment.

### DESCRIPTION OF THE EMBODIMENTS

Hereinafter, an electronic apparatus (body) 1 according to an embodiment of the present invention will be described with reference to the drawings.

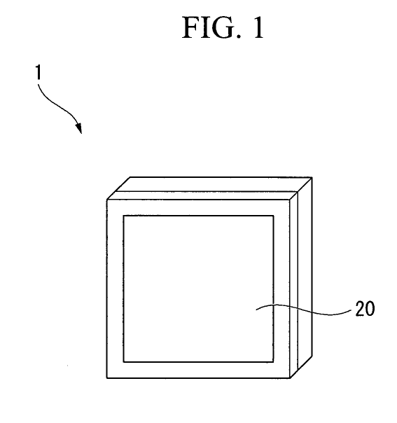

FIG. 1 is a schematic view showing an example of an external appearance of the electronic apparatus 1 according to the present embodiment.

The electronic apparatus 1 includes a display unit 20 on the front surface as shown in FIG. 1.

The electronic apparatus 1 includes a motion interface which determines the motion of the apparatus (the electronic apparatus, body) when a user holds the electronic apparatus 1 in the user's hand and moves the electronic apparatus 1, and thereby uses the motion of the apparatus as an interface. That is, the electronic apparatus 1 determines (detects) the motion of the apparatus and thereby determines (detects) the action (motion, gesture) of the user. The electronic apparatus 1 is, for example, a portable information terminal such as a mobile phone, a smartphone, and a digital camera.

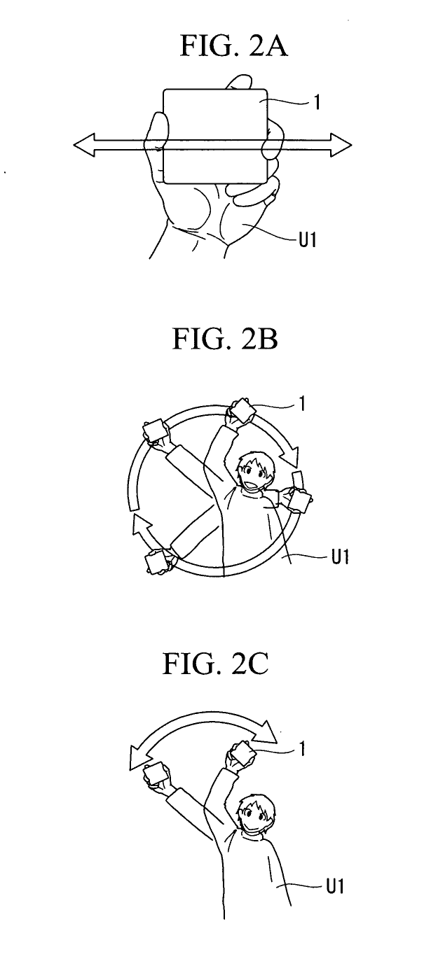

Note that, the electronic apparatus 1 in the present embodiment determines, for example, three types of motions as shown in FIGS. 2A, 2B, and 2C. The three types of motions determined by the electronic apparatus 1 are described.

FIG. 2A shows a linear movement that is a first motion (first movement) determined by the electronic apparatus 1. The linear movement is a movement in which a user U1 holds the electronic apparatus 1 and moves the electronic apparatus 1 linearly between two points.

FIG. 2B shows a circular movement (rotational movement) that is a second motion (second movement) determined by the electronic apparatus 1. The circular movement (rotational movement) is a movement in which the user U1 holds the electronic apparatus 1 and moves the electronic apparatus 1 one round such that a circular shape is drawn.

FIG. 2C shows an arc movement (reciprocating movement) that is a third motion (third movement) determined by the electronic apparatus 1. The arc movement (reciprocating movement) is a movement in which the user U1 holds the electronic apparatus 1 and moves the electronic apparatus 1, for example, in an arc manner in a moving range (action range) of 30 degrees to 90 degrees.

### First Embodiment

Next, a first embodiment according to the present invention is described.

The first embodiment is described using an example in which the electronic apparatus 1 determines the linear movement (FIG. 2A) and the circular movement (FIG. 2B) described above.

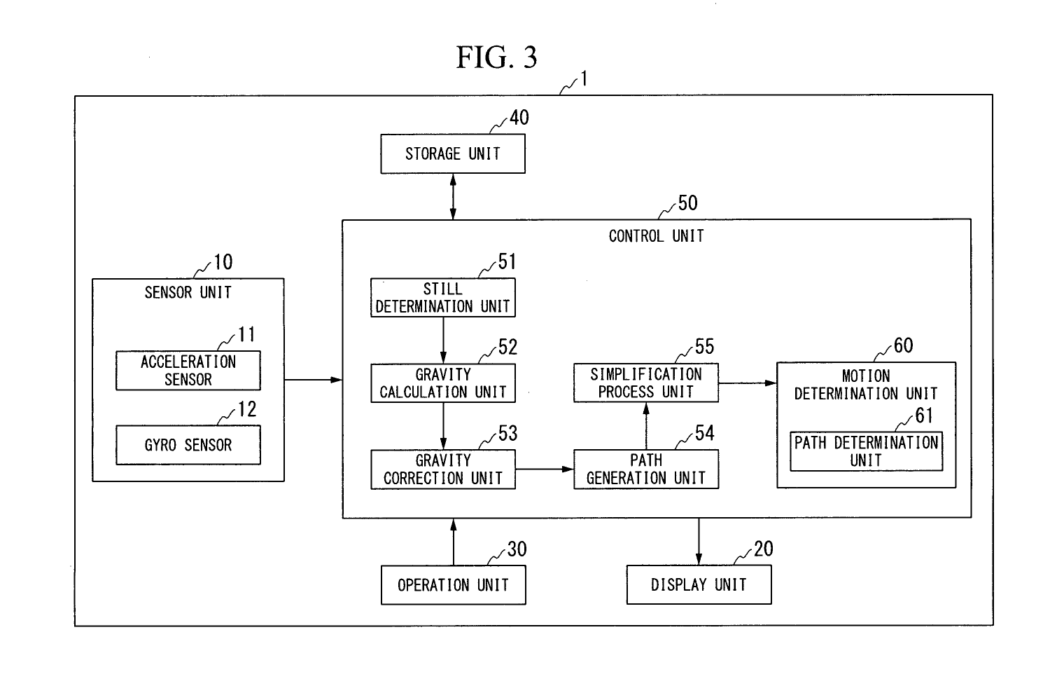

First, a configuration of the electronic apparatus 1 is described with reference to FIG. 3.

FIG. 3 is a block diagram showing the electronic apparatus 1 in the present embodiment.

In FIG. 3, the electronic apparatus 1 includes a sensor unit 10, a display unit 20, an operation unit 30, a storage unit 40, and a control unit 50.

The sensor unit 10 measures displacement information of the apparatus (body) used to detect the motion of the apparatus (body), as detection data. The sensor unit 10 has an acceleration sensor 11 that detects acceleration data and a gyro sensor 12 that detects angular velocity data. The displacement information of the apparatus (body) includes, for example, acceleration data and angular velocity data.

The acceleration sensor 11 is, for example, a three-axis acceleration sensor that detects an acceleration (acceleration data) in each of three axes orthogonal to one another (for example, X-axis, Y-axis, and Z-axis). Note that, in the present embodiment, the display surface of the display unit 20 is a XY plane, one of orthogonal directions in the XY plane is an X direction, and the other of orthogonal directions in the XY plane is a Y direction. Further, a direction perpendicular to the XY plane is a Z direction.

Further, the acceleration sensor 11 periodically detects acceleration data at a predetermined sampling period (predetermined detection interval) and outputs each acceleration data periodically detected, to the control unit 50 as the displacement information (detection data) of the apparatus.

The gyro sensor 12 (angular velocity sensor) is, for example, a three-axis angular velocity sensor that detects an angular velocity (angular velocity data) in each of three axes orthogonal to one another (for example, X-axis, Y-axis, and Z-axis). The gyro sensor 12 periodically detects angular velocity data at a predetermined sampling period (predetermined detection interval) and outputs each angular velocity data periodically detected, to the control unit 50 as the displacement information (detection data) of the apparatus.

The display unit 20 displays an image such as a still image and a moving image. As the display unit 20, for example, a liquid crystal display panel, an organic EL (Electro-Luminescence) panel, and the like are used.

The operation unit 30 is, for example, an input unit such as a touch panel and a key switch and accepts an operation by the user.

The storage unit 40 stores primary storage data used to perform each function of the electronic apparatus 1. The storage unit 40 stores, for example, the acceleration data and the angular velocity data detected by the sensor unit 10 through the control unit 50. Further, the storage unit 40 stores, for example, the standard deviation of the angular velocity data, path data, and the like described below.

The control unit 50 is, for example, a CPU (Central Processing Unit) and integrally controls the units of the electronic apparatus 1. The control unit 50 includes a still determination unit 51, a gravity calculation unit 52, a gravity correction unit 53, a path generation unit 54, a simplification process unit 55, and a motion determination unit 60.

The still determination unit 51 determines whether the electronic apparatus (body) 1 is in a still state (the action of the user U1 is motionless) or is in a moving state (the user U1 is in action) based on a change in the standard deviation of the angular velocity data detected by the gyro sensor 12 of the sensor unit 10. Note that, in the present embodiment, the still determination unit 51 determines, as an example, whether or not the electronic apparatus 1 is in a still state based on the standard deviation of the angular velocity data detected by the gyro sensor 12; however, the still determination unit 51 may determine whether or not the electronic apparatus 1 is in a still state based on the standard deviation of the acceleration data detected by the acceleration sensor 11. That is, the still determination unit 51 determines whether or not the apparatus (body) is in a still state based on the change in the standard deviation with respect to the displacement information (for example, angular velocity data) of the apparatus (body) for a predetermined number of detections detected by the sensor unit 10.

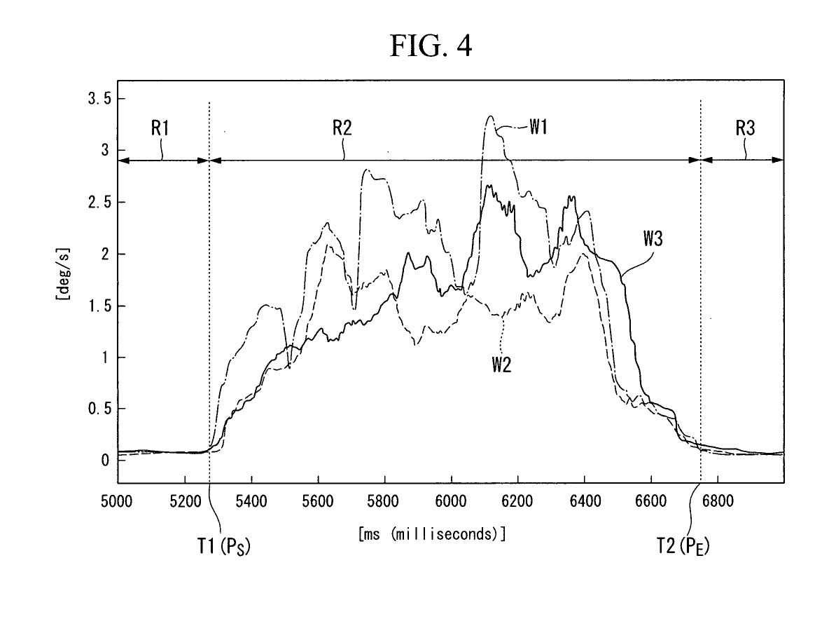

The still determination unit 51 calculates, with respect to each detection point of the angular velocity data, a standard deviation based on, for example, angular velocity data for ten times which is angular velocity data in the detection point and angular velocity data for the past nine times. The change in the standard deviation is represented by a graph as shown in FIG. 4. The detection point is one (one point) of a plurality of detection data detected at a predetermined sampling period (predetermined detection interval) by the sensor unit 10 (the acceleration sensor 11 and the gyro sensor 12).

FIG. 4 is a diagram showing a change in a standard deviation of angular velocity data of a circular movement (rotational movement) in the present embodiment.

In the graph of FIG. 4, the horizontal axis represents time (ms (milliseconds)), and the vertical axis represents a standard deviation (deg (degree)/s) of angular velocity data. A waveform W1 represents a standard deviation of angular velocity data in the X-axis direction. A waveform W2 represents a standard deviation of angular velocity data in the Y-axis direction. A waveform W3 represents a standard deviation of angular velocity data in the Z-axis direction. A time T1 represents a starting point PS of the motion of the electronic apparatus 1 (action of the user U1). A time T2 represents an end point PE of the motion of the electronic apparatus 1 (action of the user U1). Note that, “the motion of the electronic apparatus 1 (the apparatus, body)” represents a mechanical motion (movement) in a space.

The still determination unit 51 determines that the electronic apparatus is in a still state when the standard deviations of the angular velocity data in all axis directions of the standard deviations of the angular velocity data in the X-axis, Y-axis, and Z-axis directions are equal to or less than a predetermined threshold value (first threshold value). The still determination unit 51 determines that the electronic apparatus is in a moving state (in action) when at least the standard deviation of the angular velocity data in one axis direction of the standard deviations of the angular velocity data in the X-axis, Y-axis, and Z-axis directions is greater than the predetermined threshold value (first threshold value). For example, in FIG. 4, the still determination unit 51 determines a period R1 and a period R3 to be a still state and determines a period R2 to be a moving state (in action).

The gravity calculation unit 52 calculates a gravity component (gravitational acceleration) included in the acceleration data detected by the acceleration sensor 11. For example, the gravity calculation unit 52 determines the start of the motion of the apparatus (body) based on a determination result determined by the still determination unit 51. That is, the gravity calculation unit 52 determines the starting point PS of the action shown in FIG. 4. Further, the acceleration data in the starting point PS of the action is, here, first acceleration data. The gravity calculation unit 52 calculates a gravity component (gravitational acceleration) in each detection point based on the first acceleration data by using Expression (1) described below.

(gravity component)=(first acceleration data value)×(angular velocity data value) (1)

Here, the angular velocity data value is a value of angular velocity data detected by the gyro sensor 12 in each detection point and represents the direction of the electronic apparatus 1 while the electronic apparatus 1 is moving (inclination degree of the electronic apparatus 1 from the motion start). The gravity calculation unit 52 calculates a gravity component (gravitational acceleration) based on the acceleration data (first acceleration data) in the start of the motion and the angular velocity data detected by the gyro sensor 12 while the apparatus is moving, as represented by Expression (1). That is, the gravity calculation unit 52 calculates the gravity component (gravitational acceleration) in each detection point in consideration of the change in the direction due to the movement of the electronic apparatus 1 using Expression (1).

In this way, the gravity calculation unit 52 determines a start of a motion of the apparatus (body) based on a determination result determined by the still determination unit 51 and calculates a gravity component based on first acceleration data that is acceleration data in the start of the motion of the acceleration data detected by the acceleration sensor 11.

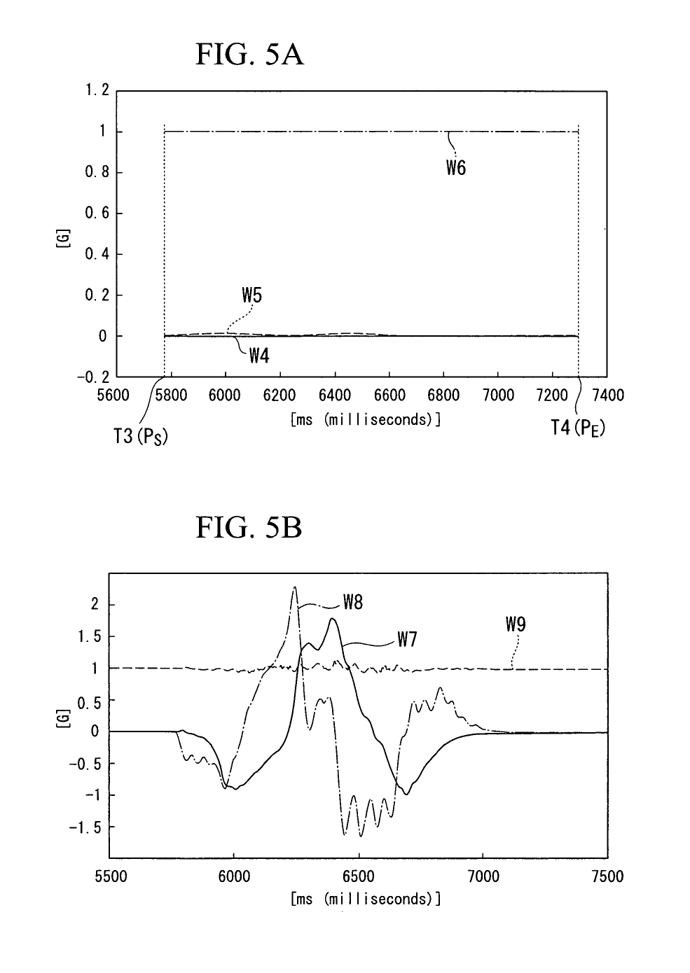

FIGS. 5A and 5B are diagrams showing an example of a comparison between a change in the gravity component calculated by the gravity calculation unit 52 and a change in the gravity component when a low-pass filter is used.

The graph shown in FIG. 5A shows a change in the gravity component calculated by the gravity calculation unit 52 when a circular movement of the electronic apparatus 1 is made by the user U1. For comparison, the graph shown in FIG. 5B shows a change in the gravity component calculated by using a low-pass filter as in the case of the related art.

In the graphs of FIGS. 5A and 5B, the horizontal axis represents time (ms (milliseconds)), and the vertical axis represents a gravity component (gravitational acceleration) (G).

In FIG. 5A, a waveform W4 represents a gravity component in the X-axis direction calculated by the gravity calculation unit 52 using Expression (1). A waveform W5 represents a gravity component in the Y-axis direction calculated by the gravity calculation unit 52 using Expression (1). A waveform W6 represents a gravity component in the Z-axis direction calculated by the gravity calculation unit 52 using Expression (1). A time T3 represents the starting point PS of the motion of the electronic apparatus 1 (action of the user U1). A time T4 represents the end point PE of the motion of the electronic apparatus 1 (action of the user U1).

In FIG. 5B, one of a waveform W7, a waveform W8, and a waveform W9 represents a gravity component that corresponds to each of the X-axis, Y-axis, and Z-axis when the gravity component is calculated by using a low-pass filter.

As shown in the waveform W4, the waveform W5, and the waveform W6, the gravity calculation unit 52 in the present embodiment is able to obtain an accurate gravity component compared to a case in which the low-pass filter of FIG. 5B is used.

The gravity correction unit (correction unit) 53 corrects second acceleration data that is acceleration data detected by the acceleration sensor 11 while the apparatus (body) is moving (moving state), based on the gravity component calculated by the gravity calculation unit 52. The gravity correction unit 53 calculates, for example, gravity removal acceleration data for each detection point, the gravity removal acceleration data being second acceleration data corrected by removing the gravity component based on Expression (2) described below.

(gravity removal acceleration data value)=(second acceleration data value)−(gravity component) (2)

That is, the gravity correction unit 53 calculates the gravity removal acceleration data by subtracting the gravity component from the acceleration data (second acceleration data) while the user U1 is in action (the apparatus is in a moving state). Thereby, the gravity correction unit 53 generates acceleration data depending only on the motion of the electronic apparatus 1.

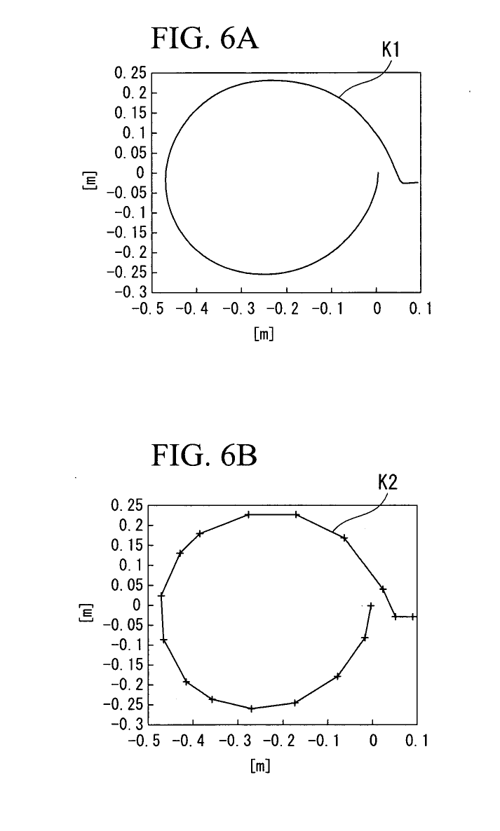

The path generation unit 54 generates a movement path of the apparatus (electronic apparatus 1, body) based on integration of double integral values of the second acceleration data (gravity removal acceleration data) corrected by the gravity correction unit 53. The path generation unit 54 calculates a movement distance according to the integration of double integral values of the gravity removal acceleration data and, for example, generates a movement path on a two-dimensional plane (refer to FIG. 6A described later).

The simplification process unit 55 changes the path generated by the path generation unit 54 to straight lines in movement directions of a predetermined number, the movement directions being different from one another, to thereby be simplified. The simplification process unit 55 performs, for example, a two-step simplification process described below. That is, the simplification process unit 55 performs a first simplification process that changes the curve of the path to straight lines to thereby be simplified and a second simplification process that changes the path simplified by the first simplification process to straight lines in movement directions of a predetermined number (for example, eight) to thereby be further simplified.

FIGS. 6A, 6B, and 6C are diagrams showing an example of a simplification process of a path in the present embodiment.

In FIGS. 6A, 6B, and 6C, each graph represents, for example, a path on the XY plane, the vertical axis represents a movement distance (m) in the vertical axis, and the horizontal axis represents a movement distance (m) in the horizontal axis.

A path K1 of FIG. 6A represents a path generated by the path generation unit 54 and represents the path before the simplification process is performed by the simplification process unit 55.

A path K2 of FIG. 6B represents a path simplified by the simplification process unit 55 performing the first simplification process described later.

A path K3 of FIG. 6C represents a path simplified by the simplification process unit 55 performing the second simplification process described later.

In the first simplification process, the simplification process unit 55 changes the curve of the path to straight lines and thereby performs simplification from the path K1 of FIG. 6A to the path K2 of FIG. 6B.

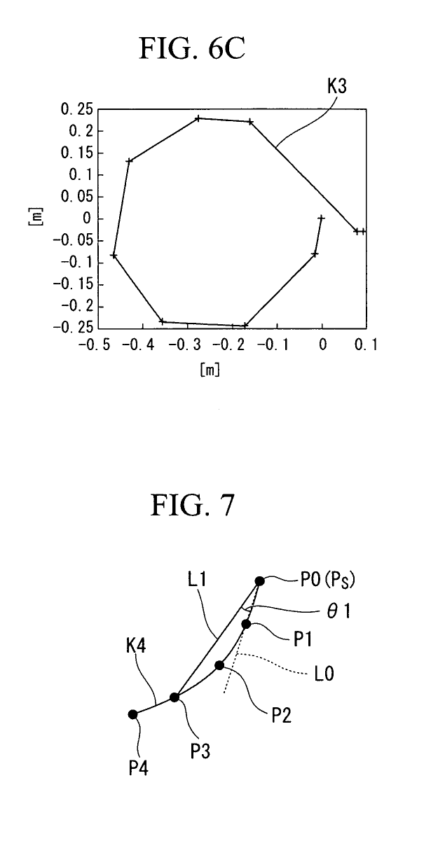

Here, the first simplification process by the simplification process unit 55 is described in detail with reference to FIG. 7.

FIG. 7 is a diagram used to describe the first simplification process of a path in the present embodiment.

In FIG. 7, a path K4 is a path generated by the path generation unit 54, and points P0 to P4 are points on the path, one of the points corresponding to each of detection points. Further, the point P0 represents the starting point PS of the movement of the electronic apparatus 1.

The simplification process unit 55 performs the following process in the first simplification process.

The simplification process unit 55 sets the starting point P0 (PS) of the path K4 generated by the path generation unit 54 to a first reference point (setting process).

The simplification process unit 55 sets a reference straight line L0 indicating a straight line from the reference point P0 to the next point P1 of the path data. The simplification process unit 55 draws straight lines from the reference point P0 to the points P2, P3, . . . of the path data in order and determines a line having an angle θ1 of the line with respect to the reference straight line L0 exceeding a predetermined angle range (for example, a range of ±30 degrees). That is, the simplification process unit 55 determines, in order of the path, a point on the path having an angle between a straight line connecting the point to the reference point P0 and the set reference straight line L0, the angle exceeding a predetermined angle range (for example, a range of ±30 degrees) on a two-dimensional plane (determination process). In an example shown in FIG. 7, a point on the path having an angle exceeding a predetermined angle range corresponds to the point P3.

The simplification process unit 55 changes the path to a straight line L1 from the reference point to the point P3 on the path, the point P3 having an angle exceeding a predetermined angle range (change process).

The simplification process unit 55 sets the point P3 on the path having an angle exceeding a predetermined angle range to the next reference point and repeats similar processes (determination process and change process described above) until the end point of the path (repeat process).

Further, in the second simplification process, the simplification process unit 55 changes the path simplified by the first simplification process, for example, to eight straight lines of movement directions, and thereby performs simplification from the path K2 of FIG. 6B to the path K3 of FIG. 6C. For example, in the second simplification process, the simplification process unit 55 divides the movement direction into eight (for example, when one round of a circular movement is 360 degrees, the one round is divided into eight by 45 degrees), allocates the eight divided straight lines of movement directions to the path K2, and thereby generates a further simplified path K3.

The motion determination unit 60 determines the motion of the apparatus (body), for example, based on the path simplified by the simplification process unit 55. That is, the motion determination unit 60 determines the motion of the apparatus (action of the user U1) based on the path generated by the path generation unit 54. The motion determination unit 60 includes a path determination unit 61.

Here, the path determination unit 61 of the motion determination unit 60 determines, for example, two motions (movements) of the linear movement and the circular movement (rotational movement).

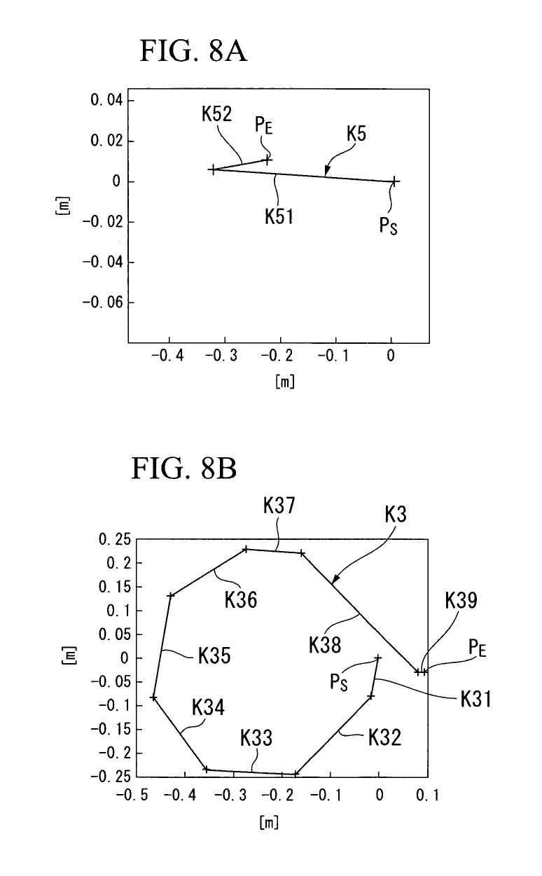

The path determination unit 61 determines that the motion is a linear movement when the path generated by the path generation unit 54 represents a movement in one direction. The path determination unit 61 determines that the motion (movement) of the apparatus is a linear movement, for example, as shown in FIG. 8A, when the path K5 simplified by the simplification process unit 55 represents a movement having a predetermined length (predetermined first length) or more, having a linear shape, and in one direction.

FIGS. 8A and 8B are diagrams showing an example of a motion determination using a path in the present embodiment.

In FIGS. 8A and 8B, similarly to FIGS. 6A, 6B, and 6C, each graph represents, for example, a path on the XY plane, the vertical axis represents a movement distance (m) in the vertical axis, and the horizontal axis represents a movement distance (m) in the horizontal axis.

FIG. 8A shows an example of a case in which a linear movement is determined. The path K5 shows an example of a path simplified by the simplification process unit 55.

In FIG. 8A, the path determination unit 61 determines that the motion is a linear movement according to a straight line K51 having a predetermined length (predetermined first length) or more in the path K5 from the starting point PS to the end point PE. Note that, the length of a straight line K52 of the path K5 is less than a predetermined length (predetermined first length) and therefore is not counted as the movement direction. In this case, the path determination unit 61 determines that the path K5 is a movement in one direction according to the straight line K51 and, as a result, determines that the motion is a linear movement.

Further, the path determination unit 61 determines that the motion is a circular movement when straight lines in a different movement direction, of movement directions of a predetermined number (for example, eight), continue successively for a predetermined number of directions (for example, seven directions) in predetermined order, from the starting point of the path simplified by the simplification process unit 55 to the end point. That is, the path determination unit 61 determines that the motion of the apparatus is a circular movement when straight lines having a predetermined length (predetermined second length) or more of different movement directions, of movement directions of a predetermined number (for example, eight), continue successively for a predetermined number of times (for example, seven times) or more, from the starting point of the simplified path to the end point.

FIG. 8B shows an example of a case in which a circular movement is determined. The path K3 shows an example of a path simplified by the simplification process unit 55.

In FIG. 8B, the path determination unit 61 determines that the motion of the apparatus is a circular movement when straight lines having a predetermined length (predetermined second length) or more continue successively, for example, for seven times or more (in this example, continue from a straight line K31 to a straight line K38), in the path K3 from the starting point PS to the end point PE. Note that, the length of a straight line K39 of the path K3 is less than a predetermined length (predetermined second length) and therefore is not counted as the movement direction. Further, the predetermined first length and the predetermined second length described above may be a length having a different value or may be a length having the same value.

Note that, since the path simplified by the simplification process unit 55 is generated based on the second acceleration data (gravity removal acceleration data) corrected by the gravity correction unit 53, the path determination unit 61 determines the motion of the apparatus based on the gravity removal acceleration data.

In this way, the motion determination unit 60 determines the motion of the apparatus (body) based on the second acceleration data (gravity removal acceleration data) corrected by the gravity correction unit 53.

Next, an operation of the electronic apparatus 1 in the present embodiment is described.

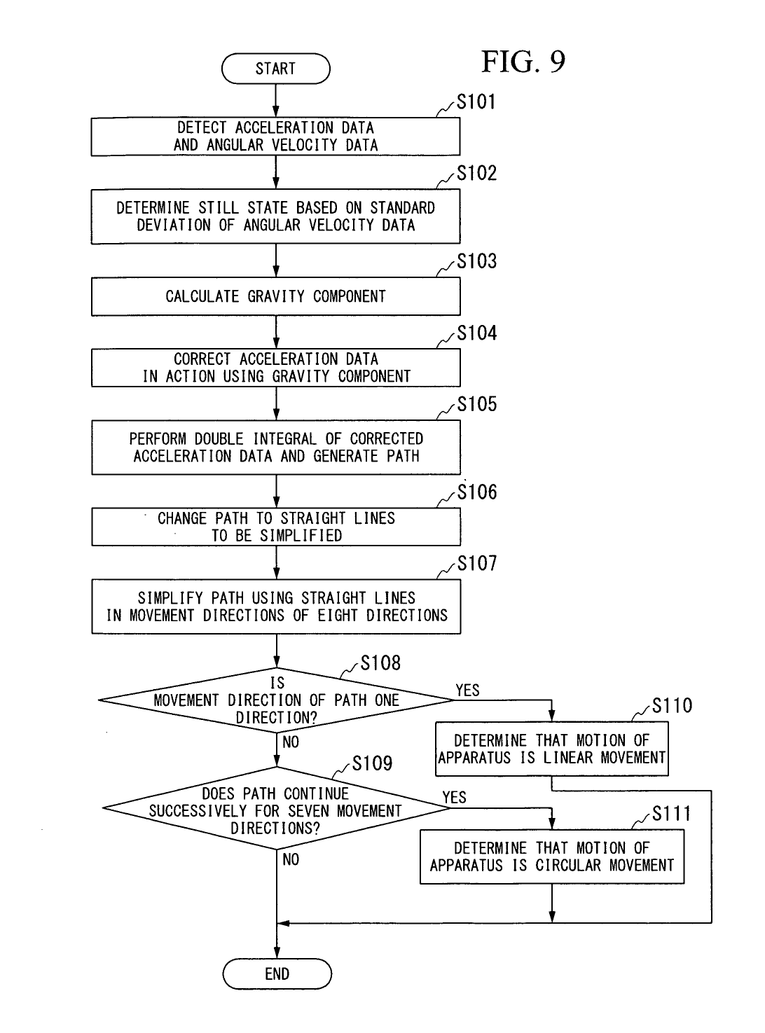

FIG. 9 is a flowchart showing a process of a motion determination of the electronic apparatus 1 in the present embodiment.

In FIG. 9, first, the sensor unit 10 detects acceleration data and angular velocity data (step S101). For example, the acceleration sensor 11 of the sensor unit 10 periodically detects acceleration data at a predetermined sampling period (predetermined detection interval) and outputs each detected acceleration data to the control unit 50 as detection data. Further, for example, the gyro sensor 12 of the sensor unit 10 periodically detects angular velocity data at a predetermined sampling period (predetermined detection interval) and outputs each detected angular velocity data to the control unit 50 as detection data. The control unit 50 stores the detection data acquired from the sensor unit 10 in the storage unit 40.

Next, the still determination unit 51 of the control unit 50 determines a still state based on the standard deviation of the angular velocity data (step S102). For example, the still determination unit 51 calculates the standard deviation based on the angular velocity data stored in the storage unit 40. The still determination unit 51 determines whether the electronic apparatus 1 is in a still state (the action of the user U1 is motionless) or is in a moving state (the user U1 is in action) based on a change in the calculated standard deviation.

Next, the gravity calculation unit 52 calculates a gravity component (gravitational acceleration) included in the acceleration data detected by the acceleration sensor 11 (step S103). For example, the gravity calculation unit 52 determines the start of the motion (starting point of the action) of the apparatus based on a determination result determined by the still determination unit 51. Further, the gravity calculation unit 52 calculates a gravity component (gravitational acceleration) in each detection point based on the acceleration data (first acceleration data) and the angular velocity data in the starting point by using Expression (1) described above.

Next, the gravity correction unit 53 corrects acceleration data in action (moving state) detected by the acceleration sensor 11 using the gravity component (step S104). For example, the gravity correction unit 53 corrects second acceleration data that is acceleration data while the apparatus is moving (moving state) based on the gravity component calculated by the gravity calculation unit 52. The gravity correction unit 53 calculates, for example, gravity removal acceleration data for each detection point, the gravity removal acceleration data being second acceleration data corrected by removing the gravity component based on Expression (2) described above.

Next, the path generation unit 54 performs double integral of the corrected acceleration data and generates a path (step S105). That is, the path generation unit 54 generates a movement path of the apparatus (electronic apparatus 1) as shown in FIG. 6A based on integration of double integral values of the second acceleration data (gravity removal acceleration data) corrected by the gravity correction unit 53.

Next, the simplification process unit 55 changes the path to straight lines to be simplified (step S106).

That is, the simplification process unit 55 simplifies the path generated by the path generation unit 54 (for example, the path K1 of FIG. 6A) to a simplified path (for example, the path K2 of FIG. 6B) using the first simplification process described above.

Next, the simplification process unit 55 simplifies the path to straight lines in movement directions of eight directions (step S107). That is, the simplification process unit 55 converts the simplified path (for example, the path K2 of FIG. 6B) according to the first simplification process into a further simplified path (for example, the path K3 of FIG. 6C), by using the second simplification process described above.

Next, the path determination unit 61 of the motion determination unit 60 determines whether or not the movement direction of the path is one direction (step S108). That is, the path determination unit 61 determines whether or not the path simplified by the simplification process unit 55 is a movement in one direction based on a straight line having a predetermined length (predetermined first length) or more. The path determination unit 61 forwards the process to step S110 when the path is a movement in one direction based on a straight line having a predetermined length (predetermined first length) or more (step S108: YES). Further, the path determination unit 61 forwards the process to step S109 when the path is not a movement in one direction based on a straight line having a predetermined length (predetermined first length) or more (step S108: NO).

Next, in step S110, the path determination unit 61 determines that the motion (movement) of the apparatus is a linear movement and completes the motion determination process.

Further, in step S109, the path determination unit 61 determines whether or not the path continues successively for seven movement directions. For example, the path determination unit 61 determines whether or not different movement directions of straight lines having a predetermined length (predetermined second length) or more, of eight movement directions, continue successively for seven times or more from the starting point of the simplified path to the end point. The path determination unit 61 forwards the process to step S111 when different movement directions of the straight lines having the predetermined length or more continue successively for seven times or more (step S109: YES). Further, the path determination unit 61 completes the motion determination process when different movement directions of the straight lines having the predetermined length or more do not continue successively for seven times or more (step S109: NO).

Next, in step S111, the path determination unit 61 determines that the motion (movement) of the apparatus is a circular movement and completes the motion determination process.

Note that, the motion determination process from step S101 of FIG. 9 to step S111 is started, for example, in response to the operation of the operation unit 30 by the user U1. Further, the electronic apparatus 1 uses the determination result determined by the motion determination process from step S101 of FIG. 9 to step S111 as a motion interface and performs a variety of processes of the electronic apparatus 1 based on the determination result.

As described above, the electronic apparatus 1 in the present embodiment includes the sensor unit 10, the still determination unit 51, the gravity calculation unit 52, the gravity correction unit 53, and the motion determination unit 60. The sensor unit 10 detects displacement information of the apparatus (body) including at least acceleration data. The still determination unit 51 determines whether or not the apparatus (body) is in a still state based on the change in the standard deviation with respect to the displacement information (detection data) of the apparatus (body) for a predetermined number of detections detected by the sensor unit 10. The gravity calculation unit 52 determines the start of the motion of the apparatus (body) based on the determination result determined by the still determination unit 51 and calculates a gravity component based on first acceleration data that is acceleration data in the start of the motion, of the acceleration data detected by the sensor unit 10. The gravity correction unit 53 corrects second acceleration data that is acceleration data detected by the sensor unit 10 while the apparatus (body) is moving, based on the gravity component calculated by the gravity calculation unit 52. The determination unit 60 determines the motion based on the second acceleration data corrected by the gravity correction unit 53.

Thus, as shown in FIG. 5A, the electronic apparatus 1 in the present embodiment is able to accurately calculate the gravity component compared to a case (FIG. 5B) in which the low-pass filter of the related art is used. Therefore, the electronic apparatus 1 in the present embodiment is able to accurately detect the acceleration data based on the motion (the action of the user U1) of the apparatus (body). Accordingly, the electronic apparatus 1 in the present embodiment is able to improve a determination rate of the motion of the apparatus (body).

Further, in the present embodiment, the sensor unit 10 detects angular velocity data as displacement information of the apparatus. The gravity calculation unit 52 calculates the gravity component (gravitational acceleration) based on the acceleration data in the start (starting point) of the motion and the angular velocity data detected by the sensor unit 10 while the apparatus is moving (in motion). Thereby, since it is possible to appropriately correct the gravity component (gravitational acceleration) in accordance with the inclination (direction) of the apparatus, the electronic apparatus 1 in the present embodiment is able to accurately calculate the gravity component (gravitational acceleration). Thus, the electronic apparatus 1 in the present embodiment is able to improve a determination rate of the motion of the apparatus.

Further, in the present embodiment, the still determination unit 51 determines the still state based on the change in the standard deviation with respect to the angular velocity data for a predetermined number of detections (for example, for ten times) detected by the sensor unit 10 as the displacement information of the apparatus.

The standard deviation of the angular velocity data represents variation in the angular velocity data, and the electronic apparatus 1 in the present embodiment is able to appropriately comprehend the change in the angular velocity data based on the change in the standard deviation of the angular velocity data. Therefore, the electronic apparatus 1 in the present embodiment is able to accurately determine the still state and is able to accurately determine the starting point of the motion (movement) and the end point. Accordingly, the electronic apparatus 1 in the present embodiment is able to improve a determination rate of the motion of the apparatus.

Note that, in the present embodiment, the still determination unit 51 may determine the still state based on the change in the standard deviation with respect to the acceleration data for a predetermined number of detections detected by the sensor unit 10 as the displacement information of the apparatus. Even in this case, similarly to the case of the angular velocity data described above, the electronic apparatus 1 in the present embodiment is able to appropriately comprehend the change in the acceleration data based on the change in the standard deviation of the acceleration data. Therefore, the electronic apparatus 1 in the present embodiment is able to accurately determine the still state and is able to accurately determine the starting point of the motion (movement) and the end point.

Further, the electronic apparatus 1 in the present embodiment includes the path generation unit 54 that generates a movement path of the apparatus based on integration of double integral values of the second acceleration data corrected by the gravity correction unit 53. The motion determination unit 60 (the path determination unit 61) determines the motion based on the path generated by the path generation unit 54.

Thereby, the electronic apparatus 1 in the present embodiment is able to accurately determine, for example, a motion (type of motions (movements)) such as a linear movement and a circular movement based on the path.

Further, in the present embodiment, the motion determination unit 60 determines that the motion of the apparatus is a linear movement when the path generated by the path generation unit 54 represents a movement having a predetermined first length or more, having a linear shape, and in one direction.

Thereby, the electronic apparatus 1 in the present embodiment is able to determine a linear movement according to a simple means.

Further, the electronic apparatus 1 in the present embodiment includes the simplification process unit 55 that simplifies the path generated by the path generation unit 54 by changing the path to straight lines in movement directions of a predetermined number (for example, eight), the movement directions being different from one another. The motion determination unit 60 determines that the motion of the apparatus is a circular movement when different movement directions of movement directions of a predetermined number continue successively for a predetermined number of times or more (for example, seven times), from the starting point of the path simplified by the simplification process unit 55 to the end point.

Thereby, the electronic apparatus 1 in the present embodiment is able to determine a circular movement according to a simple means.

Further, in the present embodiment, the simplification process unit 55 performs a first simplification process that simplifies a path by changing the curve of the path to straight lines and a second simplification process that further simplifies the path simplified by the first simplification process by changing the path to straight lines in movement directions of a predetermined number (for example, eight). The first simplification process includes: a setting process in which the starting point of the path generated by the path generation unit 54 is set to a first reference point; a determination process; a change process; and a repeat process in which the point on the path having an angle exceeding the predetermined angle range is set to the next reference point, and the determination process and the change process are repeated until the end point of the path. Here, in the determination process, a reference straight line indicating a straight line from the reference point to the next point in the path is set, and points on the path having an angle between the set reference straight line and a straight line connecting one of the points to the reference point are determined in order of the path, the angle exceeding a predetermined angle range on a two-dimensional plane. In the change process, the path is changed to a straight line from the reference point to the point on the path having an angle exceeding the predetermined angle range.

Thereby, the electronic apparatus 1 in the present embodiment is able to simplify the path generated by the path generation unit 54 as a path using straight lines, according to a simple means.

### Second Embodiment

Next, a second embodiment according to the present invention is described with reference to the drawings.

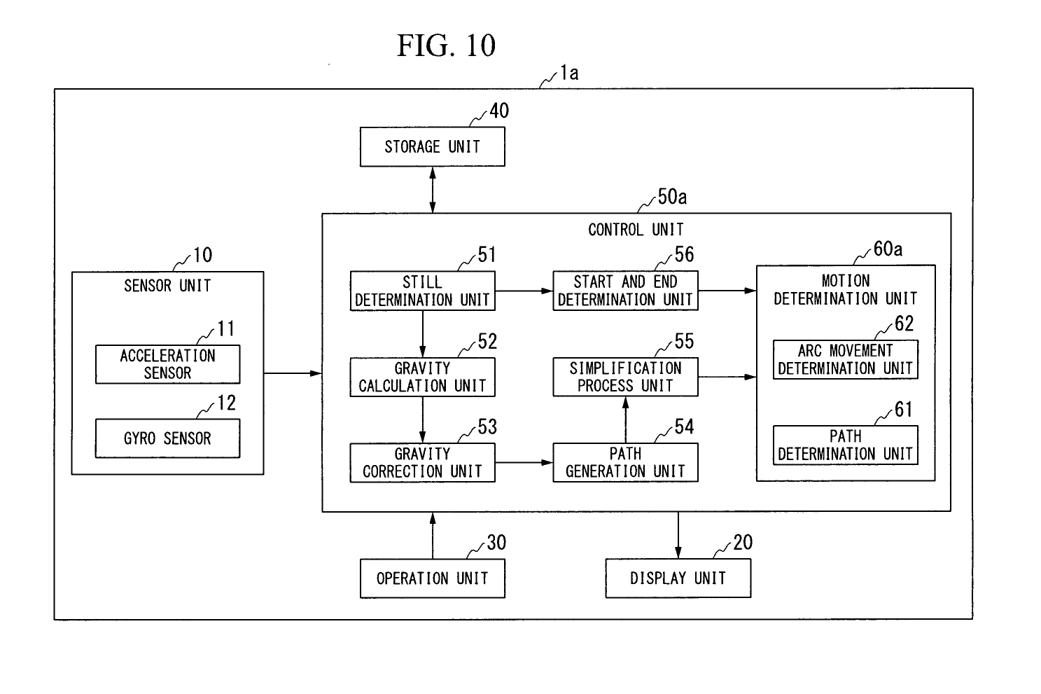

FIG. 10 is a block diagram showing an electronic apparatus (body) 1a in the present embodiment.

The present embodiment is described using an example in which the electronic apparatus 1a determines the linear movement (FIG. 2A) and the circular movement (FIG. 2B) described above and determines the arc movement (FIG. 2C) described above.

In FIG. 10, the electronic apparatus 1a includes the sensor unit 10, the display unit 20, the operation unit 30, the storage unit 40, and a control unit 50a.

Note that, in FIG. 10, a configuration identical to that in FIG. 3 is denoted by the same reference numeral, and the description of the configuration is omitted.

The present embodiment differs from the first embodiment in that a control unit 50a includes a start and end determination unit 56 and an arc movement determination unit 62, and the control unit 50a determines the arc movement.

The control unit 50a integrally controls the units of the electronic apparatus 1a similarly to the control unit 50 in the first embodiment. The control unit 50a includes the still determination unit 51, the gravity calculation unit 52, the gravity correction unit 53, the path generation unit 54, the simplification process unit 55, the start and end determination unit 56, and a motion determination unit 60a.

The motion determination unit 60a includes the path determination unit 61 and the arc movement determination unit 62.

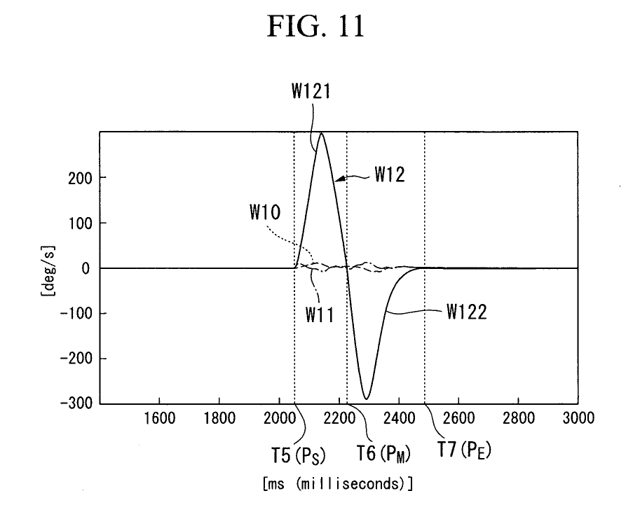

The start and end determination unit 56 determines the starting point PS (time T5 in FIG. 11) of the motion and the end point PE (time T7 in FIG. 11) of the motion, for example, when the angular velocity data detected by the gyro sensor 12 exceeds a predetermined range (predetermined threshold value range). Further, the start and end determination unit 56 determines a middle point PM (time T6 in FIG. 11) in which the direction of displacement of the apparatus (body) reverses (the positive and negative of the angular velocity data value reverse) based on the angular velocity data and the determination result (the result whether or not in a still state) determined by the still determination unit 51. The start and end determination unit 56 determines that a point is the middle point PM, for example, when the angular velocity data is within a predetermined range (predetermined threshold value range) and the motion continues. In this way, based on the determination result determined by the still determination unit 51 and the angular velocity data detected by the gyro sensor 12, the start and end determination unit 56 determines the starting point PS of the motion and the end point PE of the motion and determines the middle point PM in which the positive and negative of the angular velocity data value reverse.

FIG. 11 is a diagram showing an example of angular velocity data in an arc movement (reciprocating movement).

In the graph of FIG. 11, the horizontal axis represents time (ms (milliseconds)), and the vertical axis represents angular velocity data (deg (degree)/s). A waveform W10 represents angular velocity data in the X-axis direction. A waveform W11 represents angular velocity data in the Y-axis direction. A waveform W12 represents angular velocity data in the Z-axis direction. The time T5 represents the starting point PS of the motion of the electronic apparatus 1a. The time T6 represents the middle point PM of the motion of the electronic apparatus 1a. The time T7 represents the end point PE of the motion of the electronic apparatus 1a.

A waveform 121 of the waveform 12 represents angular velocity data from the starting point PS to the middle point PM. A waveform 122 of the waveform 12 represents angular velocity data from the middle point PM to the end point PE.

The start and end determination unit 56 outputs the determined starting point PS, the determined middle point PM, and the determined end point PE (for example, information of the time T5, the time T6, and the time T7) to the motion determination unit 60a.

The arc movement determination unit 62 of the motion determination unit 60a calculates an angle displacement amount obtained by integrating angular velocity data from the starting point PS (time T5) of the motion to the middle point PM (time T6) and an angle displacement amount obtained by integrating angular velocity data from the middle point PM (time T6) to the end point PE (time T7) of the motion. Then, the arc movement determination unit 62 determines that the motion of the apparatus (body) is an arc movement when the angle displacement amount (for example, + side) obtained by integrating angular velocity data from the starting point PS of the motion to the middle point PM is a predetermined threshold value (second threshold value) or more and when the angle displacement amount (for example, − side) obtained by integrating angular velocity data from the middle point PM to the end point PE of the motion is a predetermined threshold value (third threshold value) or more. Here, the predetermined threshold value (second threshold value) used to determine the angle displacement amount from the starting point PS of the motion to the middle point PM and the predetermined threshold value (third threshold value) used to determine the angle displacement amount from the starting point PM of the motion to the middle point PE are, for example, 30 degrees. In this way, the arc movement determination unit 62 determines a motion (movement) having a set of an action in the + direction and an action in the − direction, the actions having an angle displacement amount equal to or greater than the predetermined threshold value (for example, ±30 degrees), as an arc movement.

Note that, the path determination unit 61 of the motion determination unit 60a determines a linear movement and a circular movement similarly to the first embodiment, and therefore the description is omitted here.

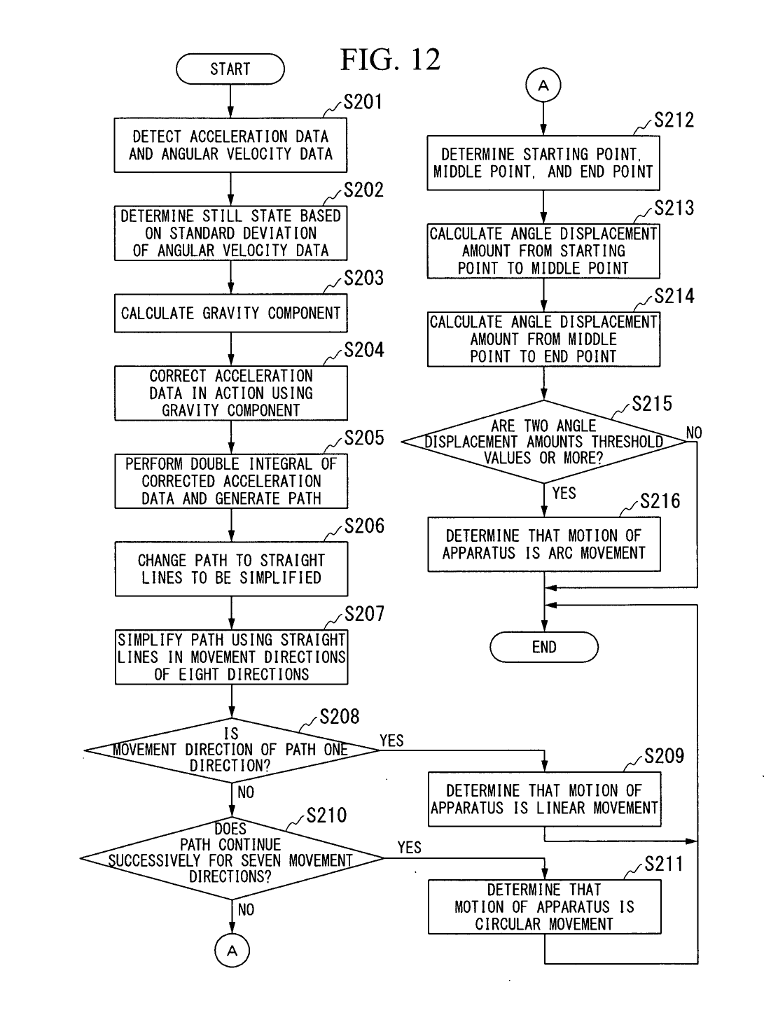

FIG. 12 is a flowchart showing a process of a motion determination of the electronic apparatus 1a in the present embodiment.

In the flowchart of FIG. 12, a process of step S201 to step S211 is similar to the process of step S101 to step Sill of FIG. 9, and the description is omitted here.

Note that, in the present embodiment, in step S210, the path determination unit 61 forwards the process to step S212 when different movement directions of the straight lines having a predetermined length or more do not continue successively for seven times or more (step S210: NO).

In step S212, the start and end determination unit 56 determines the starting point PS, the middle point PM, and the end point PE. That is, the start and end determination unit 56 determines the starting point PS (time T5 in FIG. 11) of the motion and the end point PE (time T7 in FIG. 11) of the motion, for example, when the angular velocity data detected by the gyro sensor 12 exceeds a predetermined range (predetermined threshold value range). Further, the start and end determination unit 56 determines the middle point PM (time T6 in FIG. 11) in which the positive and negative of the angular velocity data value reverse, for example, based on the angular velocity data and the determination result (the result whether or not in a still state) determined by the still determination unit 51.

Next, the arc movement determination unit 62 of the motion determination unit 60a calculates an angle displacement amount obtained by integrating angular velocity data from the starting point PS (time T5 in FIG. 11) of the motion to the middle point PM (time T6 in FIG. 11) (step S213).

Further, the arc movement determination unit 62 calculates an angle displacement amount obtained by integrating angular velocity data from the middle point PM (time T6 in FIG. 11) to the end point PE (time T7 in FIG. 11) of the motion (step S214).

Next, the arc movement determination unit 62 determines whether or not the two angle displacement amounts are predetermined threshold values (for example, 30 degrees) or more (step S215). That is, the arc movement determination unit 62 determines whether or not the angle displacement amount (for example, + side) from the starting point PS of the motion to the middle point PM is a predetermined threshold value (for example, 30 degrees) or more and the angle displacement amount (for example, − side) from the middle point PM to the end point PE of the motion is a predetermined threshold value (for example, 30 degrees) or more. The arc movement determination unit 62 forwards the process to step S216 when the two angle displacement amounts are predetermined threshold values (for example, 30 degrees) or more (step S215: YES). Further, the arc movement determination unit 62 completes the process when the two angle displacement amounts are not predetermined threshold values (for example, 30 degrees) or more (step S215: NO).

Next, in step S216, the arc movement determination unit 62 determines that the motion of the apparatus is an arc movement and completes the process. That is, the arc movement determination unit 62 determines that the motion of the apparatus is an arc movement when the angle displacement amount (for example, + side) from the starting point PS of the motion to the middle point PM is a predetermined threshold value (for example, 30 degrees) or more and when the angle displacement amount (for example, − side) from the middle point PM to the end point PE of the motion is a predetermined threshold value (for example, 30 degrees) or more.

Note that, in the processes of step S201 to step S216 described above, the motion determination process by the path determination unit 61 and the motion determination process by the arc movement determination unit 62 are described as serial processes (processes performed sequentially); however, the motion determination processes may be performed as parallel processes (processes performed in parallel).

As described above, the electronic apparatus 1a in the present embodiment includes the start and end determination unit 56 that determines, based on the determination result determined by the still determination unit 51 and the angular velocity data detected by the gyro sensor 12, the starting point PS of the motion and the end point PE of the motion and that determines the middle point PM in which the direction of displacement of the apparatus (body) reverses. The motion determination unit 60a determines the motion (for example, linear movement, circular movement) of the apparatus (body) based on the second acceleration data corrected by the gravity correction unit 53. The motion determination unit 60a determines the motion of the apparatus (body) based on the corrected second acceleration data and determines that the motion of the apparatus (body) is an arc movement when the angle displacement amount obtained by integrating angular velocity data from the starting point PS of the motion to the middle point PM is a predetermined threshold value or more and when the angle displacement amount obtained by integrating angular velocity data from the middle point PM to the end point PE of the motion is a predetermined threshold value or more.

Thereby, the electronic apparatus 1a in the present embodiment is able to determine an arc movement according to a simple means.

Further, the electronic apparatus 1a in the present embodiment includes the sensor unit 10, the still determination unit 51, the gravity calculation unit 52, the gravity correction unit 53, the path generation unit 54, the simplification process unit 55, and the path generation unit 54 of the motion determination unit 60a, similarly to the first embodiment. Therefore, the electronic apparatus 1a in the present embodiment provides advantages similar to the first embodiment.

Note that, the present invention is not limited to the above embodiments and can be changed without departing from the scope of the invention.

For example, in the above embodiments, a configuration in which the acceleration sensor 11 and the gyro sensor 12 detect three axes orthogonal to one another (for example, X-axis, Y-axis, and Z-axis) is described; however, the configuration is not limited thereto. Further, the control unit 50 (50a) may perform a calibration process in which detection data is corrected based on measurement values obtained by performing detection of the axes for a certain period of time in a still state, in order to reduce installation errors of the acceleration sensor 11 and the gyro sensor 12 and individual differences of the sensors.

Further, in the above embodiments, a configuration is described in which the still determination unit 51 determines a still state based on the standard deviation of angular velocity data detected by the gyro sensor 12; however, the still determination unit 51 may determine a still state based on the standard deviation of acceleration data detected by the acceleration sensor 11. Further, the still determination unit 51 may determine a still state based on both of the standard deviation of angular velocity data and the standard deviation of acceleration data.

Further, in the above embodiments, a configuration is described in which the simplification process unit 55 performs a two-step simplification process including a first simplification process and a second simplification process; however, a configuration may be used in which any one of the first simplification process and the second simplification process is performed. Further, a configuration is described in which, in the second simplification process, the movement direction is divided into eight; however, the configuration is not limited thereto. For example, a configuration in which the movement direction is divided into four may be used.

Further, in the above embodiments, a configuration is described in which the electronic apparatus 1 (1a) detects a linear movement, a circular movement (rotational movement), or an arc movement (reciprocating movement); however, the electronic apparatus 1 (1a) may detect another motion (movement). For example, the action (operation) by the user U1 is not limited to a gesture in which a circle (two-dimensional) or a straight line (one-dimensional) is drawn; however, the action (operation) may be a three-dimensional gesture in which a three-dimensional figure is drawn.

Further, the units included in the control unit 50 (50a) in the above embodiments may be realized by a dedicated hardware. Further, the units included in the control unit 50 (50a) may be configured by a memory and a CPU, and a program for realizing functions of the units included in the control unit 50 (50a) may be loaded into the memory and be executed to thereby realize the functions.

Further, a program for realizing the process of the control unit 50 (50a) described above may be recorded on a computer-readable recording medium. In this case, a computer system may read the program recorded on the recording medium and may execute the program, to thereby perform a process of detecting the motion of the apparatus (body). Here, the “computer system” may include an OS and hardware such as a peripheral device.

Further, the “computer-readable recording medium” refers to a storage device such as a magnetic disk, a magneto-optical disk, a SD card, a writable non-volatile memory such as a flash memory, a portable medium such as a CD-ROM, or a hard disk built in the computer system.

Further, the “computer-readable recording medium” may include a recording medium that holds a program for a predetermined time, such as a volatile memory (for example, a dynamic random access memory (DRAM)) inside the computer system that serves as a server or a client when the program is transmitted through a network such as the Internet or a communication channel such as a telephone line.

Further, the program may be transmitted to a different computer system from the computer system that stores the program in the storage device or the like through a transmission medium or by a transmission wave in the transmission medium. Here, the “transmission medium” that transmits the program refers to a medium having a function of transmitting information, such as a network (communication network) such as the Internet or a communication channel (communication line) such as a telephone line.

Further, the program may realize part of the above-described functions.

Further, the program may be a file capable of realizing the functions in cooperation with a program recorded in the computer system in advance, a so-called differential file (differential program).

1. An electronic apparatus comprising:
a sensor unit configured to detect displacement information of a body including at least acceleration data;
a still determination unit configured to determine whether or not the body is in a still state based on a change in a standard deviation with respect to the displacement information for a predetermined number of detections detected by the sensor unit;
a gravity calculation unit configured to determine a start of a motion of the body based on a determination result determined by the still determination unit and calculate a gravity component based on first acceleration data that is acceleration data in the start of the motion of acceleration data detected by the sensor unit;
a correction unit configured to correct second acceleration data that is acceleration data detected by the sensor unit while the body is moving, based on the gravity component calculated by the gravity calculation unit; and
a motion determination unit configured to determine the motion based on the second acceleration data corrected by the correction unit.

2. The electronic apparatus according to claim 1, wherein
the displacement information includes angular velocity data of the body, and
the gravity calculation unit calculates the gravity component based on the acceleration data in the start of the motion and the angular velocity data detected by the sensor unit while the body is moving.

3. The electronic apparatus according to claim 2, wherein
the still determination unit determines the still state based on the change in the standard deviation with respect to the angular velocity data for the predetermined number of detections detected as the displacement information by the sensor unit.

4. The electronic apparatus according to claim 2, further comprising:
a start and end determination unit configured to determine, based on a determination result determined by the still determination unit and the angular velocity data detected by the sensor unit, a starting point of the motion and an end point of the motion and determine a middle point in which a direction of displacement of the body reverses, wherein
the motion determination unit determines the motion based on the second acceleration data corrected by the correction unit and determines that the motion is an arc movement when an angle displacement amount obtained by integrating the angular velocity data from the starting point of the motion to the middle point is a predetermined threshold value or more and when an angle displacement amount obtained by integrating the angular velocity data from the middle point to the end point of the motion is a predetermined threshold value or more.

5. The electronic apparatus according to claim 1, further comprising:
a path generation unit configured to generate a movement path of the body based on integration of double integral values of the second acceleration data corrected by the correction unit, wherein
the motion determination unit determines the motion based on the path generated by the path generation unit.

6. The electronic apparatus according to claim 5, wherein
the motion determination unit determines that the motion is a linear movement when the path generated by the path generation unit represents a movement having a predetermined first length or more, having a linear shape, and in one direction.

7. The electronic apparatus according to claim 5, further comprising:
a simplification process unit configured to simplify the path by changing the path to straight lines in movement directions of a predetermined number, the movement directions being different from one another, wherein
the motion determination unit determines that the motion is a circular movement when straight lines having a predetermined second length or more of the different movement directions, of the movement directions of the predetermined number, continue successively for a predetermined number of times or more, from the starting point of the path simplified by the simplification process unit to the end point.

8. The electronic apparatus according to claim 7, wherein
the simplification process unit performs a first simplification process that changes a curve of the path to straight lines to thereby be simplified and a second simplification process that changes the path simplified by the first simplification process to straight lines in the movement directions of the predetermined number to thereby be further simplified, wherein
the first simplification process comprises:
a setting process of setting a starting point of the path generated by the path generation unit to a first reference point;
a determination process of setting a reference straight line indicating a straight line from the reference point to the next point in the path and determining, in order of the path, points on the path having an angle between the set reference straight line and a straight line connecting one of the points to the reference point, the angle exceeding a predetermined angle range on a two-dimensional plane;
a change process of changing the path to a straight line from the reference point to the point on the path having an angle exceeding the predetermined angle range; and
a repeat process of setting the point on the path having an angle exceeding the predetermined angle range to the next reference point and repeating the determination process and the change process until the end point of the path.

9. The electronic apparatus according to claim 1, wherein
the still determination unit determines the still state based on the change in the standard deviation with respect to the acceleration data for the predetermined number of detections detected as the displacement information by the sensor unit.

10. A program for causing a computer to execute:
a still determination step of, by way of a still determination unit, determining whether or not a body is in a still state based on a change in a standard deviation with respect to displacement information for a predetermined number of detections detected by a sensor unit, the sensor unit being configured to detect the displacement information of the body including at least acceleration data;
a gravity component calculation step of, by way of a gravity calculation unit, determining a start of a motion of the body based on a determination result determined in the still determination step and calculating a gravity component based on first acceleration data that is acceleration data in the start of the motion of acceleration data detected by the sensor unit;
a correction step of, by way of a correction unit, correcting second acceleration data that is acceleration data detected by the sensor unit while the body is moving, based on the gravity component calculated by the gravity calculation unit; and
a motion determination step of, by way of a motion determination unit, determining the motion based on the second acceleration data corrected in the correction step.
